(19) United States
(12) Patent Application Publication
(10) Pub. No.: US 2007/0088797 A1
(43) Pub. Date: Apr. 19, 2007

(54) Information technology system with application portal control

(75) Inventors: Christopher Michael Boone, San Francisco, CA (US); Costantino Lucisano, El Cerrito, CA (US)

Correspondence Address: DAVID E. LOVEJOY, REG. NO. 22,748, 102 REED RANCH ROAD, TIBURON, CA, 94920-2025, US

(73) Assignee: UTILIT TECHNOLOGIES, INC.

(21) Appl. No.: 11/253,944

(22) Filed: Oct. 19, 2005

(51) Int. Cl. G06F 15/16

(52) U.S. Cl. 709/217

(57) ABSTRACT

Disclosed is a computer system for providing functions to users at user devices connected by a network. A server connected to the network delivers functions and information to the users. A plurality of user devices are connected to the network where each user device displays a portal to enable users to request the functions from the server. Each user device displays multiple regions in the portal including a first region for display of function information from one or more of the functions and including one or more second regions, lockable by the server to prevent changes by users, for display of the server-controlled information.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The invention relates to information processing methods and apparatus for providing information through applications and functions in a distributed information technology system to users at potentially many different networked locations.

The demand by users for information, resulting from applications and functions provided by networked information technology systems (including computing, telephony, storage, display and other information systems of all types) has grown at an astounding pace. Many aspects of life now depend upon such information technology systems to provide information needed and wanted in everyday activities. The providing of information to users, and the applications and functions that create that information, is done at entities and enterprises of all sizes from major corporations and other large enterprises down to small businesses and individuals. Individual users have increasing demands for information technology systems whether or not such individual users are associated with any particular enterprise.

The architecture of information processing systems is changing to meet the demands of enterprises and individual users by providing greater access to information. Users are mobile and want information that is available wherever the users are located. This demand has surfaced with a large growth in wirelessly networked (“wireless fidelity” or “Wi-Fi”) computers. Frequently, the computers are small portable computers running full operating systems such as Microsoft Windows or equivalents. Increasingly, the computers are thin clients without full operating systems and without full hardware or may also be Personal Digital Assistants (“PDAs”), mobile phones, or other web-enabled devices.

If a user visits locations within a single enterprise or a user visits hotels, airport lounges, coffee shops or other locations at multiple enterprises, the availability of an Internet connection is frequently provided by one or more enterprises. Wayport, T-Mobile and Boingo are popular Internet access providers that operate at many different locations. Wireless connections are becoming available on a region-wide basis without requirement for being located on the premises of any particular enterprise.

While Internet access is becoming wide spread, the functions demanded by users are not satisfied by merely providing access to networks alone. Users want and increasingly are demanding computer program applications such as Microsoft Office, Open Office, web browsers, Adobe Reader, voice over IP (internet protocol), soft phone telephony and many other functions. Such other functions in addition to such applications include print/copy/fax/scan operations, directory listing and file organization operations, storage and retrieval operations and other information processing and information technology operations of all kinds. These functions are desirably available wherever the user is located and whenever the user wants access to the functions.

The distributed availability of application programs has been offered by a number of vendors such as Citrix Systems, Inc. The Citrix system is generally described in U.S. Pat. No. 6,785,726 B1 ('726 patent). The '726 patent describes client/server systems in which the server executes one or more applications for a client. The client/server system is commercially available as the WINFRAME system from Citrix Systems, Inc and includes a number of application servers. Each application server can support multi-tasking of several applications that may be requested by a user at a workstation or other user device remotely located from the server.

In order to minimize response time, maximize system throughput, and generally give the appearance that the user's application program is executing at the client, an administrator will often provide a user with access to a number of application servers that host the desired applications that are capable of servicing the user's requests. However, in order for such a system to operate efficiently, the application servers must dynamically coordinate access to system resources shared among the application servers as well as coordinate access to the application servers by the user. One way in which this coordination is done is by selecting one server from the group to act as the “master server” where the master server is responsible for keeping track of resource usage both by users and application servers. In other embodiments, multiple master servers are employed or no master server is employed and the coordination is distributed among the servers.

The '726 patent relates to a method and apparatus for delivering events to local and remote servers. In the '726 patent, different groups are formed by a plurality of servers where the servers of a group are connected by an event bus. The system posts local events on the local event bus and remote events go to a remote event bus.

Server-based computing is alternatively referred to as server-centric, centralized, mainframe, application-server, or client-server computing. In such server-based computing, applications are resident, executed and supported at the server as distinguished from at the user device. Similarly, in server-based computing systems, data is stored on the server and need not be permanently stored at the user device. After a session on a user device is terminated in a server-based computing system, any new session that follows on a user device requires that data be re-accessed at the server. User device operations (including key strokes, mouse clicks, and screen images) are communicated over the network between user device and server. The user device can be a terminal, work station, Mac, PC, terminal emulation software, thin client, handheld computer, PDA or other user device.

Computers and other user devices support a large increase in delivery of information to users. Information is delivered through web browsing, e-mail, voice, video and other ways. The information is in any form and often is a notice such as an advertisement. Many advertisers deliver ads over browsers to users and the practice has become widespread and commercially important. In response to the proliferation of such notices and advertisements, many software products and services have become available to block unwanted intrusion of ads and other notices to users.

When a user is web browsing, the control of the information on the desktop of a user device is by browser companies (“web content portals”) such as MSN, Yahoo, AOL and Google as well as by the servers of the direct web pages accessed by user request. Many different types of ads appear on the user's desktop during web browsing and these ads are at times appealing to users, but at other times ads are annoying to users. The serving of ads to users can be beneficial to users when information of interest to users is delivered to users. The cost of providing information to users is supported by ad revenue derived from advertisers.

The process of delivery of ads that are acceptable to and welcomed by users needs improvement. Currently online ad-serving engines examine web page content and deliver advertisements (“ads”) based on the respective web page content. As a result ads are not targeted to a particular end-user nor are they relevant to applications or content beyond that particular web page. Ads that are of no interest to a user are annoying. Ads that are coupled with valued services to users are more welcomed by the users. Advertisers have a great interest in improved advertising delivery and quality through increased targeting, improved ad relevancy and application independence. Such advertising represents greater revenue to advertisers.

The display and serving of ads, notices or other information usually occurs only when a user is actively web browsing. Whenever a user device is being used for other purposes such as computer program applications (for example, word processing or other office programs), no ad-serving occurs. It has been estimated that as much as 75 percent or more of a user's time on a user device occurs when the user device is in a non-ad-serving mode. Hence, from the perspective of advertisers, a large amount of untapped user time is unavailable for advertising.

While the delivery of information through server-based applications and other functions is increasing, there is a need for improved server systems and user devices.

### SUMMARY OF THE INVENTION

The present invention is an information technology system for providing functions to users at user devices connected at times by a network. A server connected to the network delivers functions and information to the users. A plurality of user devices are connected to the network where each user device displays a portal to enable users to request the functions from the server. Each user device displays multiple regions in the portal including a first region for display of function information from one or more of the functions and including one or more second regions, lockable by the server to prevent changes by users, for display of the server-controlled information.

In one embodiment, the central server provides distributed availability of application programs to the user devices. One or more of the applications displays in the first region under control of a user interacting with the user device. A navigation bar in one of the second regions presents navigation choices to users. Other second regions include a top bar and a side bar under exclusive control of the server. In one embodiment, the top bar and the side bar are used for displaying ads or other information under control of the server and lockable by the server to prevent changes by users. Regardless of which application is being used and controlled by the user, ads or other notification information is served under control of the server.

In embodiments where, at times, the user device does not have network connection to a server, local application portal operation occurs where information in the regions controlled exclusively by the server is provided by a cache that stores a history of ads or other server information down-loaded from the server when networked operation was present

In embodiments where security is of interest, information exchanged between the user device and the server is stored exclusively in a single protected directory on the user device and the server and user device cooperate to guarantee the security of information in the protected directory.

In the present invention, the display and serving of ads, notices or other information may occur up to 100 percent of the time that a user is actively using a user device. Since the user in some embodiments cannot alter the display of the server-controlled regions, a large increase in the amount of time that ads or other notices are served occurs. Accordingly, the present invention greatly enhances the amount of time for serving ads or other notices to users.

The present invention provides these and other features that will be apparent from the following description.

### BRIEF DESCRIPTION OF THE DRAWINGS

FIG. 1 depicts a block diagram of an information technology system including one or more central servers and a plurality of user devices.

FIG. 2 depicts a block diagram of a user device including an application portal.

FIG. 3 depicts a block diagram of a user-device display including a local desktop with an icon for accessing an application portal.

FIG. 4 depicts a block diagram of a user-device display including a local desktop and a locally executing application displayed above the local desktop and above any application portal that may be present.

FIG. 5 depicts a block diagram of a user-device display including an application portal and a remotely executing application displayed within a region of the portal.

FIG. 6 depicts a block diagram of a sequence employed for initiating an application portal for each user device 5 of FIG. 1.

FIG. 7 depicts a block diagram of a draw bar sequence employed as part of establishing the application portal in FIG. 6.

FIG. 8 depicts a block diagram of a distributed service system including one or more central servers and a plurality of sites where each site includes a plurality of network-connected user devices.

### DETAILED DESCRIPTION

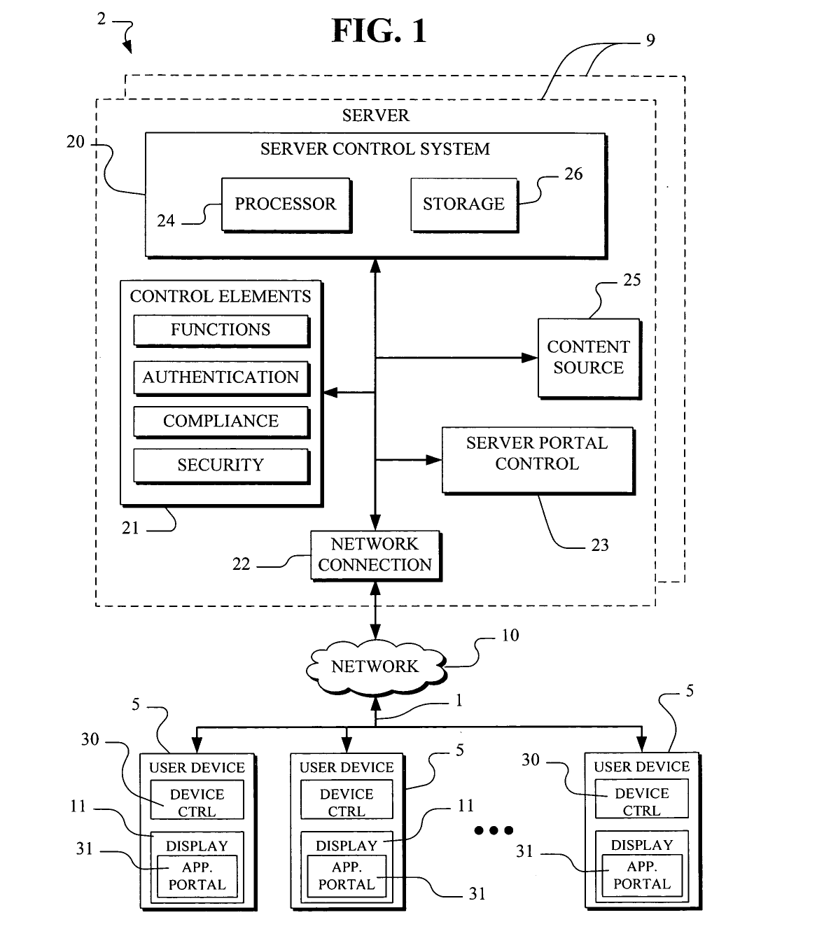

FIG. 1 depicts a distributed service system 2 where central servers 9 provide distributed availability of application programs and other functions on the displays 11 of user devices 5 through application portals 31. In FIG. 1, each user device 5 is a thin client, a full client, a personal data assistant (PDA), a telephone hand set or other information technology device.

Each of the user devices 5 is connectable or disconnectable to the servers 9 through connection or disconnection by connection 1 over the network 10. The central servers 9 operate using a server control system 20 which may include a server-centric system from Citrix Systems, Inc, Provision Networks, Tarantella or others. The server control system 20 includes a processor 24 for executing, at a server 9, applications and other functions for each of the network-connected user devices 5. The server control system 20 may or may not include storage 26 for storing data for user devices 5. The server control system 20 is able to perform all of the operations at the server 9 site that are often performed locally by full (“fat”) user devices 5. Such applications are typically any of the applications available from Microsoft such as the applications of Microsoft Office (Word, Excel, PowerPoint and so forth), Microsoft Visio and applications available from other vendors such as Open Office, Adobe Acrobat and in general, any application available from any vendor.

Referring to FIG. 1, the client user devices 5 can be located at the same or at different sites. The sites may be connected by local area networks or wide area networks and may be present at locations anywhere around the world. The server 9, in addition to the server control system 20, includes control elements 21, network connection 22, server portal control 23 and content source 25.

The control elements 21 include additional elements to those found in the server control system 20 such as enhanced functions, authentication, compliance and security. The network connection 22 provides network connections to network 10 and the user devices 5. The server portal control 23 functions to control the application portals 31 on each of the user devices 5. The content source 25 provides the content, under control of server 9, in addition to the application content provided to the user devices 5 by the processor 24.

Full client user devices include desktop computers, laptop computers, PC's, MAC's and other information technology systems that typically have disk drives and full operating systems. Most PC's use a windows operating system which currently is typically the XP Operating System from Microsoft Corporation. Full clients generally have the capacity to modify the operating system and have tended to be easily corrupted. In order to reduce the security risks inherent in full clients, extensive security software is essential to guard against viruses, hacker tools, trojans, malware, spyware, malicious programs, harmful scripts and other elements presenting security risks.

Thin clients are computer processors designed to be small and simple, usually without a disk drive, so that the bulk of the information processing for the user occurs on the network-connected server 9. User devices 5 that are thin clients in the distributed service system 2 typically do not have all of the capabilities of PCs or other full-client devices. Thin clients in server-based computing systems most commonly do not have persistent storage devices for client data and do not execute programs. Thin clients typically run simplified operating systems. Typically, the thin client does not have the capability of modifying the operating system configuration. Although thin clients as user devices 5 are not as easily corrupted as full clients, thin clients still must be operated so as to prevent security risks.

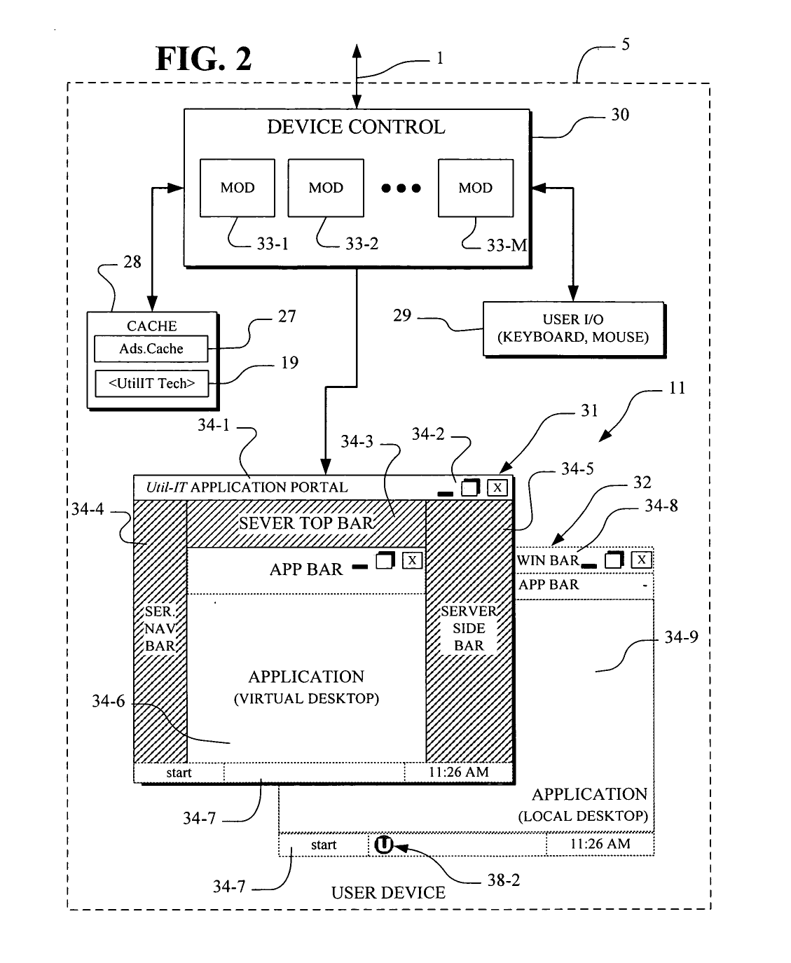

FIG. 2 depicts a block diagram of a user device 5, with connection 1 to the network 10 of FIG. 1, including a device control 30 and an application portal 31 running on top of a local desktop 32 on a display 11. The user device 5 includes a cache 28 and includes user I/O 29 such as a keyboard, mouse and other devices. The cache 28 stores a directory (<UtilIT Tech>) 19 that is controlled by the remote server 9 of FIG. 1 and the device control 30 of FIG. 2. For security operations, information exchanged between the user device 5 and the server 9 is stored exclusively in a single protected directory (<UtilIT Tech>) 19 on the user device cache 28 of FIG. 2 and the server 9 and user device 5 cooperate to guarantee the security of information in that protected directory. In FIG. 2, an ads cache 27 is provided in cache 28 for storing ads from the remote server 9 of FIG. 1 for display by the user device 5

The FIG. 2 desktop configuration is for a full client implementation of user device 5 having a local desktop 32. In a thin client embodiment of user device 5, typically only the application portal 31 is present without a local desktop 32.

The device control 30 includes a plurality of modules 33 (MOD) including modules 33-1, 33-2, . . . , 33-M for controlling the application portal 31 and other operation of the user device 5. When the user device 5 is network connected to the server 9 of FIG. 1, the device control 30 operates in response to the server 9 to control the application portal 31. When the user device 5 is not network connected to the server 9 of FIG. 1, the device control 30 operates with local control of the application portal 31 or the local desktop 32. Typically, the modules 33 include a local operating system, such as Windows XP from Microsoft Corporation.

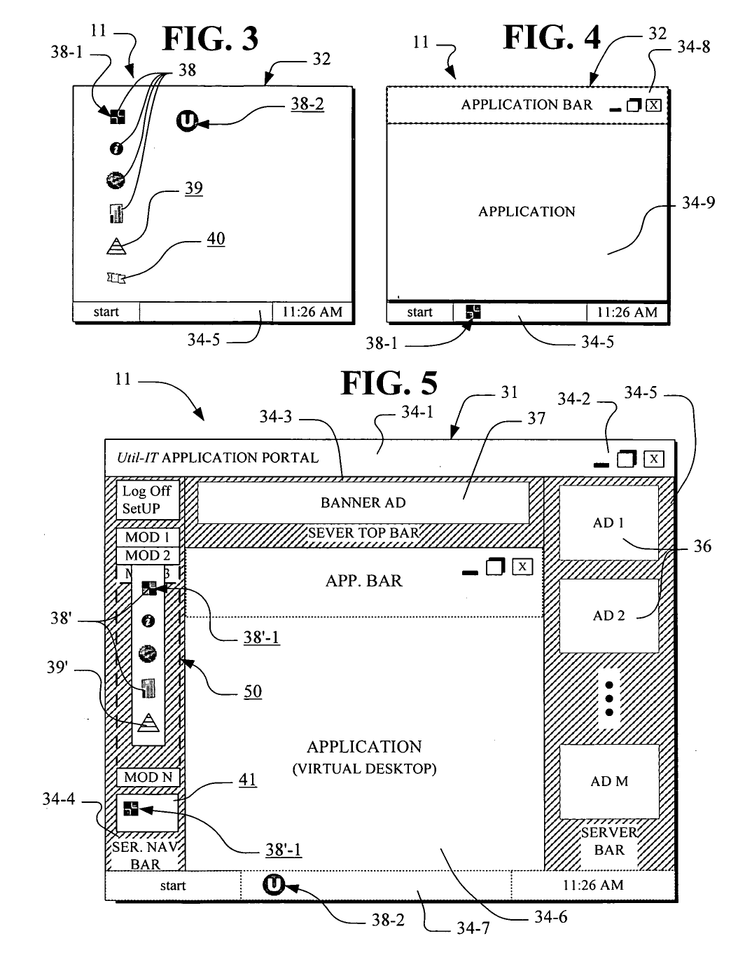

In FIG. 2, the application portal 31 has a number of components that are under control of the device control 30 and the server portal control 23 of FIG. 1. The application portal 31 components include a server window bar 34-1 that identifies the virtual window with the Util-IT logo. The server window bar includes a size control 34-2 that has a small control icon “_” to minimize the application portal 31, a full screen icon “□” to expand the application portal 31 to the full screen size and close icon “X” to close the application portal. When the application portal is closed, the display 11 reverts to a local desktop 32 view such as shown in FIG. 3 and in FIG. 4. The application portal 31 includes an application component 34-6 that is used for any applications that are of interest to the user using the user device 5. The application component 34-6 displays application information, and more generically function information where the function is an application, in a distinct first region of the display 11 of FIG. 2 The application portal 31 includes a number of components that are exclusively under control of the device control 30, and indirectly the server portal control 23 in FIG. 1, including the server top bar 34-3, the server navigation bar 34-4 and the server side bar 34-5.

The server top bar 34-3, in one example, is used for displaying banner ads and can be used to display other information deemed desirable by the server 9. The server navigation bar 34-4, in one example, is used for displaying navigation icons, navigation links and other controls for use by a user in selecting and controlling the application 34-6 of interest to the user. Each application 34-6 is an example of a function executed by the server 9 of FIG. 1 and the server 9 provides function information to the display region of application 34-6. The user interacts to control the function utilizing the USER I/O 29 of FIG. 2. For example, where the function is a word processor, the word processing document is displayed as the function information and that document is controlled by the user interactively with the I/O device 29 of FIG. 2. The server navigation bar 34-4 can be used to display other information deemed desirable by the server 9. The server side bar 34-5, in one example, is used for displaying one or more ads, notices or other information deemed desirable by the server 9. The task bar 34-7 is the task bar of the local desktop 32 which typically can be displayed on top, or hidden, under user control. The task bar 34-7 typically displays an application portal icon 38-2 whenever the application portal 31 is active. Typically, the application portal 31 is always active when the user device 5 is network-connected to the server 9.

The application portal 31 of FIG. 2 operates in a number of different modes. In the mode shown, a local desktop 32 is also active and a user can switch between the application portal 31 and local desktop 32. The local desktop 32 typically is running on a user device 5 that is a full client such as a PC running a windows operating system such as Windows XP. In the local desktop 32 environment, any number of locally installed and licensed application programs can be executed locally by the user from the local desktop 32. Such applications are typically any of the applications available from Microsoft such as the applications of Microsoft Office (Word, Excel, PowerPoint and so forth), Microsoft Visio, Adobe Acrobat and any other PC application.

In the application portal 31 environment, any number of server-installed and licensed application programs can be executed remotely by the user under control of the application portal 31. Such applications are typically any of the applications available from Microsoft such as the applications of Microsoft Office (Word, Excel, PowerPoint and so forth), Microsoft Visio, Adobe Acrobat and any other application made available by the server 9.

In an environment where the user device 5 is a thin client, then only virtual mode operation is available to the user. In an environment where the user device 5 is not connected by a network to server 9, then only execution under the local desktop 32 is available. However, in some embodiments, in order to avoid unnecessary complexity to a user, local desktop operation is performed with a pseudo-virtual display that appears as the virtual mode application portal display while actual execution is mapped to local desktop operation. Under normal virtual mode application portal operation, storage of information occurs on the server 9, while in local mode operation, information is cached in storage cache 28 on the user device 5. When caching is used on the user device 5, synchronization between the user device cache 28 and the server 9 storage 26 of FIG. 1 occurs whenever the network connection is again made active between the user device 5 and the server 9.

In one preferred embodiment, virtual mode operation using application portal 31 is preferred whereby the user is relieved of many responsibilities with respect to installation, configuration, licensing, updating, upgrading, security and other matters normally the responsibility of a user. Also, the server 9 normally has processing power that exceeds the processing power of a user device 5 and hence greater performance is expected from the virtual mode operation provided that the bandwidth of the network link through network 10 between the user device 5 and the server 9 is adequate.

The virtual mode operation when provided as a service also has the advantage that the server 9 controls the application portal display in the regions of bars 34-1, 34-2, 34-3, 34-4, 34-5 and 34-6 while leaving control of the application 34-6 to the user. The manner in which the server 9 controls the application portal display in the regions of regions of bars 34-1, 34-2, 34-3, 34-4, 34-5 and 34-6 is a function of the type of virtual mode service offered to users. In one typical example, a low price (or free) service is provided to users of the application portal 31 and the user devices, in exchange for a low price, display ads in the server top bar 34-3 and the server side bar 34-5 during all operations of an application or applications in the application region 34-6. In another typical example, the virtual mode operation, virtual mode service is purchased by either an individual or an employer for multiple employees and the employer elects to serve employee-relevant notices or other information in the bars 34-3 and 34-5. In such an example, the employer may chose to hide the bars 34-3 and 34-5, or allow the user to hide the bars 34-3 and 34-5, under certain circumstances. Under other circumstances, such as an employer-wide, department-wide, or individual employee notices, the server 9 operates to direct notices or other information directly to the bars 34-3 and 34-5 of the relevant ones of the employees using the virtual mode operation without the ability of the user to hide the information. Many different types of notices or other information may be served. For example, as described, employee notices including meeting announcements, company policies, alerts whether of an emergency nature or otherwise, company news, job openings and so forth.

FIG. 3 depicts a block diagram of a user-device display including a local desktop 32 as it appears, for example, when no local application is executing. The desktop includes a number of icons 38 and icons 39 and 40 representing applications available to run on the local desktop. The applications include, for example, Microsoft Office (Word, Excel, PowerPoint and so forth), a browser such as Internet Explorer, Microsoft Visio, Adobe Acrobat and any other locally executable applications of interest to a user. In the FIG. 3 example, icon 39 represents a browser (Internet Explorer) and icon 40 represents a unique application of interest to a particular user, but of limited demand by other users. The icon 38-1, in a typical example, is for Word from Microsoft Office. The icon 38-2 represents the application portal 31.

In FIG. 3, task bar 34-5 is a conventional task bar of the type used in Windows XP, for example, and includes the conventional “start” icon and the time display “11:26 AM”. Additional tool bars are added to the task bar 34-5 in a conventional Windows manner.

FIG. 4 depicts a block diagram of a display 11 of a user-device 5 including a local desktop 32 and a locally executing application 34-9 which is represented by the icon 38-1 of FIG. 3. The icon 38-1 of FIG. 3 appears in the task bar 34-5 of FIG. 4 indicating that application 34-9 is a locally executing application on the local desktop 32. The application 34-9 is for example, Word from Microsoft Office.

FIG. 5 depicts a block diagram of a display 11 of a user-device 5 including an application portal 31 and a remotely executing application 34-6. The application 34-6 is, for example, Word from Microsoft Office. The appearance and operation of the executing application 34-6 in FIG. 5 within the application region of the application portal 31 is the same appearance and operation as the application 34-9 in FIG. 4 on the local desktop 32 except that the application 34-6 is executing on the server 9 of FIG. 1 while the application 34-9 is executing locally on a full client user device 5.

In addition to the application region for application 34-6, the FIG. 5 appearance and operation includes the server-controlled bars 34-4, 34-3 and 34-5 that are under control of the device control 30 of FIG. 2 and the server portal control 23 of FIG. 1. The application portal 31 components include a server window bar 34-1 that identifies the virtual window with the Util-IT logo for the application portal. The server window bar 34-1 includes a size control 34-2 that has a small control icon “_” to minimize the application portal 31, a full screen icon “□” to expand the application portal 31 to the full screen size and close icon “X” to close the application portal 31. If the minimize control icon “_” is used while the application portal 31 is executing, the screen reverts, for example, to the FIG. 3 or FIG. 4 view, except that the application portal icon 38-2 remains in the task bar 34-7 as shown in FIG. 5. When the application portal is intended to be closed by selecting the close icon “X”, a popup window is shown in one embodiment to query if the application portal 31 is to be closed. If closed, then the local desktop 32 of FIG. 3 is revealed and the application portal 31 is restarted by selecting the icon 38-2.

The server navigation bar 34-4, in one example, is used for displaying navigation icons, navigation links and other controls for use by a user in selecting and controlling the application 34-6 of interest to the user. The server navigation bar 34-4 can be used to display other information deemed desirable by the server 9.

In FIG. 5, the navigation bar 34-4 includes, for example, N modules 50 including modules MOD 1, MOD 2, . . . , MOD N. The module MOD 2, for example, includes a pop-down list of virtual application icons 38′ representing applications that are executable on the remote server 9 of FIG. 1. The application icon 38′-1 is, for example, for Microsoft Word, the same as the application represented by icon 38-1 on the local desktop of FIG. 1 and FIG. 2. The application icon 38′-1 appears in a navigation bar window 41 to indicate which applications (or other function) under control of the user are executing on the application portal 31 in the region of the application 34-6.

In FIG. 5, the application portal 31 includes a number of additional components that are exclusively under control of the device control 30 of FIG. 2, and indirectly the server portal control 23 in FIG. 1, including the server top bar 34-3 and the server side bar 34-5. The server top bar 34-3, in one example, is used for displaying a banner ad 37 and can be used to display other notices or information deemed desirable by the server 9. The server side bar 34-5, in one example, is used for displaying one or more ads, notices or other information deemed desirable by the server 9. In the example of FIG. 5, the side bar 34-5 has M ad regions 36 including regions AD 1, AD 2, . . . , AD M.

There are a number of different methods for delivering ads, notices and other information in the server-controlled regions 34-3, 34-4 and 34-5 of the application portal 31. These include banners, buttons, pop-up (down, side) windows, text lines having hyperlinks to web sites or links to other locations. Various different technologies are available for delivering ads including images and Flash. Typically, images are either in GIF or JPEG format. In general, GIF images are better for ads containing text and JPEG images are better for pictures. Flash is a vector-based animation which allows advertisements or other notices to have rich graphics and animation in a relatively small file size.

The larger the file size of an ad, the longer it takes to display the ad. Marketing reports have shown slower ads have lower click-thru rates. The same reports have also shown that ad effectiveness increases as the size of the ad increases. The use of rich media in banner ads increases ad effectiveness. Animated ads are about 18 times more effective then static GIF/JPEG images.

For some embodiments of an application portal, image ads are grouped into three sizes, small, medium and large. Typically, the file size of an image ad is about 15 KB to 20 KB and the file size of a Flash animation is 1 MB. The following TABLE 1 summarizes the industry standards for image ads:

TABLE 1

| | | Ad size | Max File Size |
|---|---|---|---|
| | Type name | (pixels) | (KB) |
| Large | Large Rectangle | 336 × 280 | 92 |
| | Skycraper | 120 × 600 | 71 |
| | Full Banner | 468 × 60 | 28 |
| | 3/4 Banner | 392 × 72 | 28 |
| | Vertical Banner/Small Skyscraper | 120 × 240 | 29 |
| Medium | Half Banner | 234 × 60 | 14 |
| | Square Button | 125 × 125 | 16 |
| Small | Button 1 | 120 × 100 | 12 |
| | Button 2 | 120 × 90 | 11 |
| | Button 3 | 120 × 60 | 8 |

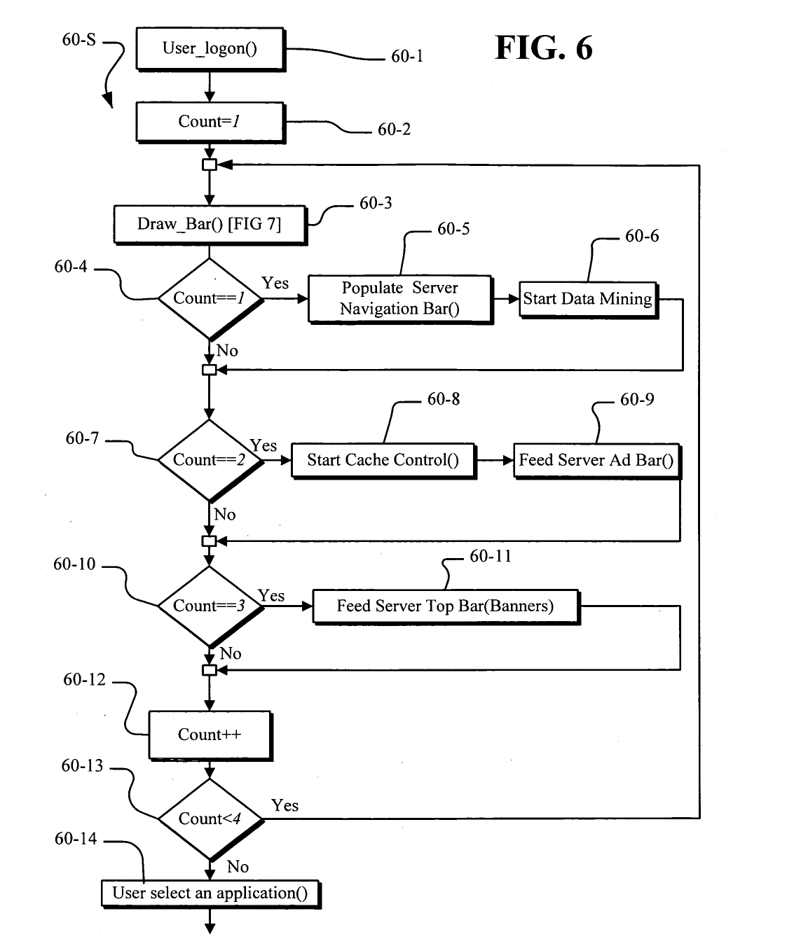

FIG. 6 depicts a block diagram of a sequence employed for initiating, installing and operating the application portal for each user device 5 of FIG. 1. The sequence establishes the bars 34-3, 34-4 and 34-5 of FIG. 2 and FIG. 5 that display the server-controlled information. The sequence is controlled by the server portal control 23 of FIG. 1 together with the device control 30 of FIG. 2. The modules 33-1, 33-2, . . . , 33-M in device control 30 of FIG. 2 correspond to the modules 60-1, 60-2, . . . , 60-14 of FIG. 6 and corresponding modules in server portal control 23 of FIG. 1. Typically, the modules 33-1, 33-2, . . . , 33-M in device control 30 of FIG. 2 are downloaded to the device control 30 of each user device 5 of FIG. 2 from server control 23 of FIG. 1 and then are executed with calls to the local operating system, such as Microsoft Windows XP. The FIG. 6 sequence commences when a user logs on through operation of the module 60-1. The logon is typically accompanied by various additional elements that are executed, for example, the control elements 21 of FIG. 1 including functions, authentication, compliance and security algorithms.

After the algorithms of logon module 60-1 are executed, FIG. 6 steps through three sequences for establishing the bars 34-3, 34-4 and 34-5 of FIG. 2 and FIG. 5. The three sequences are counted one at a time by a count that steps from 1 to 4 and then exits to allow a user to select an application or other function for remote execution on the server 9. While three sequences have been described in FIG. 6 for the three bars 34-3, 34-4 and 34-5 of FIG. 2 and FIG. 5, any number of sequences can be executed to establish any number of bars on the portal display.

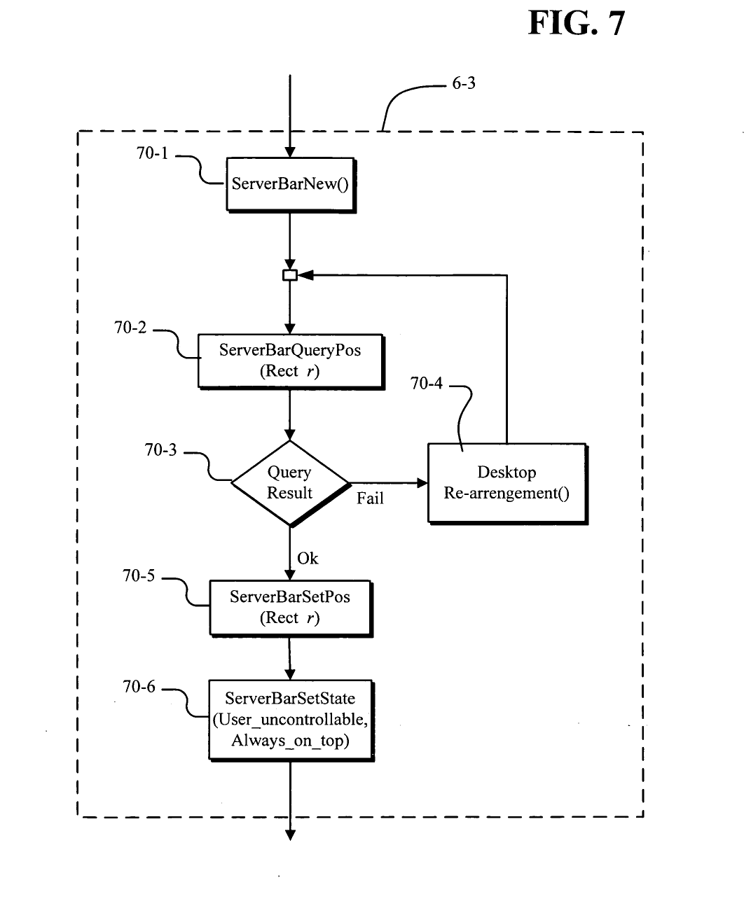

In module 60-2, the count is set equal to 1 and the navigation bar 34-4 is drawn by the draw_bar module 60-3 as shown in detail in FIG. 7.

In module 60-4, the count is tested and if equal to 1, the “Yes” leg is selected and the module 60-5 populates the navigation bar 34-4 with the icons and other components as indicated in FIG. 5. The module 60-6 starts data mining which includes algorithms for detecting what operations are being performed by the user device 5 during the periods of time that users are logged on. The data mining may be of many forms including analysis of web browsing, word processing and other applications executed by any logged on users as well as personal data (age, occupation, interests and other information) consensually made available by users subscribing to the application portal service.

The sequence is then returned to the count path and is examined in module 60-7 to determine if the count is equal to 2 and the first time through is not so the “No” leg is selected. The count path continues and is examined in module 60-10 to determine if the count is equal to 3 and the first time through is not so the “No” leg is selected. The count path continues and the count is incremented by 1 in module 60-12 to a count of 2. Next the count is examined in module 60-13 to determine if the count is less than 4 and the first time through is, so the “Yes” leg is selected returning to the draw_bar module 60-3.

The draw_bar module 60-3 then draws the bar 34-5 as shown in detail in FIG. 7. In module 60-4, the count is again tested and now if not equal to 1, the “No” leg is selected and the sequence continues on the count path and is examined in module 60-7 to determine if the count is equal to 2, and the second time through is equal to 2, so the “Yes” leg is selected. The start cache control module 60-8 operates to initialize and control operation of the cache 28 in FIG. 2. The cache 28 receives ads or other information supplied by the content source 25 of FIG. 1 and otherwise stores information useful to the operation of the user device 5. The module 60-9 commences feeding the ad bar 34-5 with the ads AD 1, AD 2, . . . , AD M supplied by the content source 25 of FIG. 1 and stored in the cache 28 of FIG. 2.

The sequence is then returned to the count path and is examined in module 60-10 to determine if the count is equal to 3 and the second time through is not so the “No” leg is selected. The count path continues and the count is incremented by 1 in module 60-12 to a count of 3. Next the count is examined in module 60-13 to determine if the count is less than 4 and the second time through is less than 3 and the “Yes” leg is selected returning to the draw_bar module 60-3.

The draw_bar module 60-3 then draws the bar 34-3 as shown in detail in FIG. 7. In module 60-4, the count is again tested and now if not equal to 1, the “No” leg is selected and the sequence continues on the count path and is examined in module 60-7 to determine if the count is equal to 2, and the third time through is equal to 3, so the “No” leg is selected.

The sequence is then examined in module 60-10 to determine if the count is equal to 3 and the third time through is equal to 3 and the “Yes” leg is selected. The module 60-11 operates to start serving the server top bar 34-3 with banner ads under control of the ads supplied by the content source 25 of FIG. 1 as stored in the cache 28 of FIG. 2.

The count path continues and the count is incremented by 1 in module 60-12 to a count of 4. Next the count is examined in module 60-13 to determine if the count is less than 4 and after the third time through is equal to 4 and the “No” leg is selected passing execution to the module 60-14 that permits a user to select an application for execution. For each of the “Yes” legs of the modules 60-4, 60-7 and 60-10, the FIG. 6 processing executes the draw_bar module 60-3 shown in detail in FIG. 7.

In FIG. 7, the module 70-1 communicates with the local operating system to setup a new server bar. The module 70-2 proposes a bar (one of the bars 34-3, 34-4 or 34-5) with respective rectangular coordinates at r. The module 70-2 queries the operating system as to the availability of a bar at the proposed location. The module 70-3 determines if the query result was “Ok” or was a “Fail”. If a “Fail”, the module 70-4 proposes a rearrangement of the bar to a new location and the modules 70-2 and 70-3 are re-executed. When the proposed location of the new bar is acceptable to the operating system, the “Ok” leg of the module 70-3 is selected and the module 70-5 sets the bar position. Thereafter, the module 70-6 sets parameters for the newly created bar to be “User_uncontrollable” and “Always_on_top”.

The sequence of FIG. 6, in cooperation with the sequence of FIG. 7, initiates a portal with a first region for display for functions under user control and with one or more second regions under server control for display of server-controlled information. The sequence of FIG. 6 includes a sequencer 60-S (modules 60-2, 60-4, 60-7, 60-10, 60-12 and 60-13) for sequencing from an initial value, I, (in FIG. 6 I=1) to a final value, F, (in FIG. 6 F=4) where the number of iterations is F-I (in FIG. 6, 4−1=3). Each iteration of the sequencer 60-S cycles through the region creator, module 60-3 (Draw_Bar) in FIG. 6, and for three iterations, creates three regions, the regions 34-3, 34-4 and 34-5 of FIG. 2 and FIG. 5.

Advertising Bars and Information Bars. The system 2 of FIG. 1 provides for the deliver of notices such as ads directly on the application portal 31 displays of user devices 5 using a server-controlled application portal 31 of FIG. 2 and FIG. 5. This delivery is done by creating and locking controlled regions (regions 34-3, 34-4 and 34-5 of FIG. 2 and FIG. 5) on the application portal 31. Typically, the server-controlled regions are populated by 3rd party targeted search engines, such as DoubleClick, Google, MSN, Yahoo and other vendors which are well known for serving Ad boxes and Text links. The ads serving regions 34-3 and 34-5 of FIG. 2 and FIG. 5 occupy, in one example, 20% of the total display area of application portal 31.

The delivery of ads on the application portal 31 is application independent, unlike systems which deliver ads based on web page content alone, and delivery of ads occurs during execution of essentially all applications (including, for example, Microsoft Outlook, Word, Excel, PowerPoint or any other application or function). The serving server-controlled information is not under the control of the user. The serving of server-controlled information is remotely controlled by the server 9. The ads are controlled by the server 9 and hence are, if the server desires, independent of any user control and can always be displayed on top. Typically, users enter into an agreement to receive ads under favorable terms and conditions acceptable to and desired by the user.

A user having an account connects through user device 5 to the remote service provided by server 9 and then the server 9 deploys the application portal 31 with the Application Desktop Toolbars (“Appbars”) such as bars 34-1, 34-2, 34-3, 34-4 and 34-5 as described in connection with FIG. 5.

An appbar is a particular kind of windows application that is typically aligned to the right or left edge, or top or bottom, of the screen display, and when it is docked, if some other window is maximized, the appbar is still visible because the system controls the rest of the windows to operate in a smaller working area. An example of an appbar is the windows TaskBar 34-7, that is, the bar with the list of opened applications that is typically present in every Windows Desktop. The TaskBar 34-7 is under user control and can be displayed or hidden by the user.

Upon initial user log on (see module 60-1 of FIG. 6), the code starts determining the kind of client device/mode for the user device 5 and user currently connected to the remote server 9 service. If the client type is of a category for receiving ads, then the creation of the ads regions are completed as described in connection with FIG. 6, for example. The initial query is as shown in the following TABLE 2.

TABLE 2
Copyright © UTILIT TECHNOLOGIES, INC. 2005

cl_type = client_device( );
If(serve_ads(cl_type))
{
create_ads_region( );
}

The implementation of the Ads Serving Regions as described in FIG. 6 follows an object oriented development scheme using the programming language C# to develop a class named ApplicationDesktopToolbar. In other embodiments, Ad Serving Regions may be created through additional programming languages including C++, Java, Visual Basic and others. In the embodiment described, this class inherits from the windows predefined class System.Windows.Forms.Form.

The Ads Serving Regions communicate with the windows operating system through the API function called SHAppBarMessage. This function has two parameters, the first is the message to be sent to the operating system, and the second parameter is a structure data type containing additional information regarding the message to be sent. An example is the following TABLE 3.

TABLE 3
Copyright © UTILIT TECHNOLOGIES, INC. 2005

[DllImport(“shell32.dll”)]
public static extern UInt32 SHAppBarMessage(

| | |
|---|---|
| UInt32 dwMessage, | // Appbar message value to send. |
| ref APPBARDATA pData); | // pointer to an APPBARDATA |

structure.
// The content of the structure depends
on the
// value recorded in the dwMessage
parameter.

[StructLayout(LayoutKind.Sequential)]
public struct APPBARDATA
{

public UInt32 cbSize;
public IntPtr hWnd;
public UInt32 uCallbackMessage;
public UInt32 uEdge;
public RECT rc;
public Int32 lParam;

}

Note that the parameter dwMessage is the message being sent and it can be one of the following enumerating values of TABLE 4

TABLE 4
Copyright © UTILIT TECHNOLOGIES, INC. 2005

public enum AppBarMessages
{

| | |
|---|---|
| New | = 0x00000000, |
| Remove | = 0x00000001, |
| QueryPos | = 0x00000002, |
| SetPos | = 0x00000003, |
| GetState | = 0x00000004, |
| GetTaskBarPos | = 0x00000005, |
| Activate | = 0x00000006, |
| GetAutoHideBar | = 0x00000007, |
| SetAutoHideBar | = 0x00000008, |
| WindowPosChanged | = 0x00000009, |
| SetState | = 0x0000000a |

}

Using the aforementioned API SHAppBarMessage( ) a function such as module 70-1 in FIG. 7 registers the bar for an Ads Serving Region as an appbar into the operating system appbars list. This registration is implemented, for example, by the following TABLE 5:

TABLE 5
Copyright © UTILIT TECHNOLOGIES, INC. 2005

private Boolean AppbarNew( )
{

// prepare data structure of message
ShellApi.APPBARDATA msgData = new
ShellApi.APPBARDATA( );
msgData.cbSize = (UInt32)Marshal.SizeOf(msgData);
msgData.hWnd = Handle;
msgData.uCallbackMessage = RegisterCallbackMessage( );
// install new appbar
UInt32 retVal =
ShellApi.SHAppBarMessage((UInt32)AppBarMessages.New,

ref msgData);

return (retVal!=0);

}

After creating the bar serving region, code for the module 70-2 of FIG. 7 sets the proposed bar region size and location as shown, for example, in the following TABLE 6:

TABLE 6
Copyright © UTILIT TECHNOLOGIES, INC. 2005

private void SizeAppBar( )
{

// set the info for the proposed rectangle
ShellApi.RECT rt = new ShellApi.RECT( );
if((m_Edge == AppBarEdges.Left) ∥

(m_Edge == AppBarEdges.Right))

{

rt.top = 0;
rt.bottom = SystemInformation.PrimaryMonitorSize.Height;
if(m_Edge == AppBarEdges.Left)
{

rt.right = m_PrevSize.Width;

}
else
{

rt.right = SystemInformation.PrimaryMonitorSize.Width;
rt.left = rt.right − m_PrevSize.Width;

}

}
else
{

rt.left = 0;
rt.right = SystemInformation.PrimaryMonitorSize.Width;
if (m_Edge == AppBarEdges.Top)
{

rt.bottom = m_PrevSize.Height;

}
else
{

rt.bottom = SystemInformation.PrimaryMonitorSize.Height;
rt.top = rt.bottom − m_PrevSize.Height;

}

}

After setting the proposed bar region size and location, the resulting rectangle is checked with a query by the module 70-3 of FIG. 7 as shown, for example, in the following TABLE 7:

TABLE 7
Copyright © UTILIT TECHNOLOGIES, INC. 2005

// Check the proposed rectangle

AppbarQueryPos(ref rt);
switch (m_Edge)
{

case AppBarEdges.Left:

rt.right = rt.left + m_PrevSize.Width;
break;

case AppBarEdges.Right:

rt.left= rt.right − m_PrevSize.Width;
break;

case AppBarEdges.Top:

rt.bottom = rt.top + m_PrevSize.Height;
break;

case AppBarEdges.Bottom:

rt.top = rt.bottom − m_PrevSize.Height;
break;

}

After the resulting rectangle is checked with a query by the module 70-3 of FIG. 7, if the rectangle does not fit, an application portal re-arrangement is performed of module 70-4 of FIG. 7 and the modules of TABLE 6 and of TABLE 7 are repeated until the query result is “Ok”. Then the position of the bar is set by the module 70-5 of FIG. 7 as shown, for example, in the following TABLE 8:

TABLE 8
Copyright © UTILIT TECHNOLOGIES, INC. 2005

// Set the proposed rectangle using

AppbarSetPos(ref it);
// Step 3: Do the actual moving of the window
Location = new Point(rt.left,rt.top);
Size = new Size(rt.right − rt.left,rt.bottom − rt.top);

}
private void AppbarQueryPos(ref ShellApi.RECT appRect)
{

// set data struct of message
ShellApi.APPBARDATA msgData = new
ShellApi.APPBARDATA( );
msgData.cbSize = (UInt32)Marshal.SizeOf(msgData);
msgData.hWnd = Handle;
msgData.uEdge = (UInt32)m_Edge;
msgData.rc = appRect;
// query postion for the appbar
ShellApi.SHAppBarMessage((UInt32)AppBarMessages.QueryPos,
ref msgData);
appRect = msgData.rc;

}

The function of the module 70-6 of FIG. 7 sets the state of the bar region to be always-on-top and not closeable by the user as shown, for example, in the following TABLE 9:

TABLE 9
Copyright © UTILIT TECHNOLOGIES, INC. 2005

```
private void AppbarSetTaskbarState(AppBarStates state)
{
  // prepare data structure of message
  ShellApi.APPBARDATA msgData = new ShellApi.APPBARDATA( );
  msgData.cbSize = (UInt32)Marshal.SizeOf(msgData);
  msgData.lParam = (Int32)state;
  // set taskbar state
  ShellApi.SHAppBarMessage((UInt32)AppBarMessages.SetState,
```

ref msgData);

}

The module 70-6 of FIG. 7 is loaded from the server 9 to the user device 5 and functions to lock the one or more regions, such as regions 34-3, 34-4 and 34-5 of FIG. 2 and FIG. 5, to prevent changes by the users of user devices 5. Accordingly, the sever-controlled information such as ads, service information and control information, cannot be altered or closed by the users.

The operation of the modules of FIG. 7 creates the regions on the portal 31 of FIG. 2 and FIG. 5. In summary the operation includes the following steps:
1. Initiate creation of a new region on the portal display with module 70-1, {ServerBarNew( )},
2. Propose a new region position on the portal display with module 70-2, {ServerBarQueryPos (Rect r)},
3. Query to determine if the new region position conflicts with any other region position with module 70-3, {Query Result},
4. If the new region position conflicts {Fail} with any other region position, re-arrange the desktop with module 70-4, {Desktop Re-arrangement), and repeat steps 2 and 3, else,
5. If the new region position does not conflict {Ok} with any other region position, set the new region position on the portal display with module 70-5, ServerBarSetPos (Rect r)},
6. Lock the new region position so as to be always-on-top and not closeable by a user with module 70-6, {ServerBarSetState (User_uncontrollable, Always_on_top)}

The Ads Serving Regions using the bars created by the FIG. 6 and FIG. 7 operations are populated with ads by one or more servers such as content source 25 of FIG. 1 which serves ad boxes and text links. The following TABLE 10 is an example of code that will provide ads to the serving region from a remote server 9:

TABLE 10
Copyright © UTILIT TECHNOLOGIES, INC. 2005

<script type=“text/javascript”><!--

server_ad_client = “pub-6701947510979140”;
server_ad_width = 160;
server_ad_height = 480;
server_ad_format = “160x600_as”;
server_ad_type = “text_image”;
server_ad_channel =“”;
//--></script>

<script type=“text/javascript”
src=“http://pagead2.serversyndication.com/pagead/show_ads.js”>
</script>

Ads Caching. Referring to FIG. 2, an ads cache 27 is provided in cache 28 for storing ads from the remote server 9 of FIG. 1 for display by the user device 5 in the regions 34-3 and 34-5. The ads cache 27 is a module functioning as a buffer recording the latest n ads from the server 9. Whenever a client user device 5 goes off-line and no network connection to the server 9 is available, the ads are still served to the user device 5 from the ads cache 27.

The ads cache 27 of FIG. 2 is a circular buffer that is used for data transfer between two processes. The server-information process for supplying ads or other information from the content source 25 on the remote server 9 of FIG. 1 places ads or other server-information into the circular buffer and the user device 5 of FIG. 2 executes the display process and displays the ads or other server-information in the server-controlled regions, for example, server-controlled regions 34-3, 34-4 and 34-5. Whenever the user device 5 is connected to the server 9, the server-information process fills the buffer, such as the ads cache 27 of FIG. 2, with up to n buffer items of server information. The buffering process is represented in detail, by way of example, in the following TABLE 11.

TABLE 11
Copyright © UTILIT TECHNOLOGIES, INC. 2005

using System;
namespace Ads.Cache
{

public class Cache : ServicedComponent
{

private ADS_STRUCT _data;
private int Count;
public Cache( ) { }
public void Enqueue(ADS_STRUCT p)
{

```
if((Count+1 > capacity))
{
  ResetCB( );
  Count=0;
}
Else
```

{

loadcb(p);
Count++;

}

CopyAds(_data,p);

}
public ADS_STRUCT GetData( )
{

return_data;

}
public void SetData(ADS_STRUCT ads)
{

CopyAds(_data,ads);

}

}

}

TABLE 11 functions as a cache for storing server-controlled information such as ads, wherein when one or more of the user devices 5, disconnectable from said server 9, is disconnected, the user device 5 operates under local control. Under local control, the user devices 5 execute the display processes and sequentially displays the n stored values of server-controlled information. Whenever a user device 5 is connected to the server 9, the cache 28 through TABLE 11 operation is refreshed with up to the latest n stored values of server-controlled information from the content source 25 of FIG. 1.

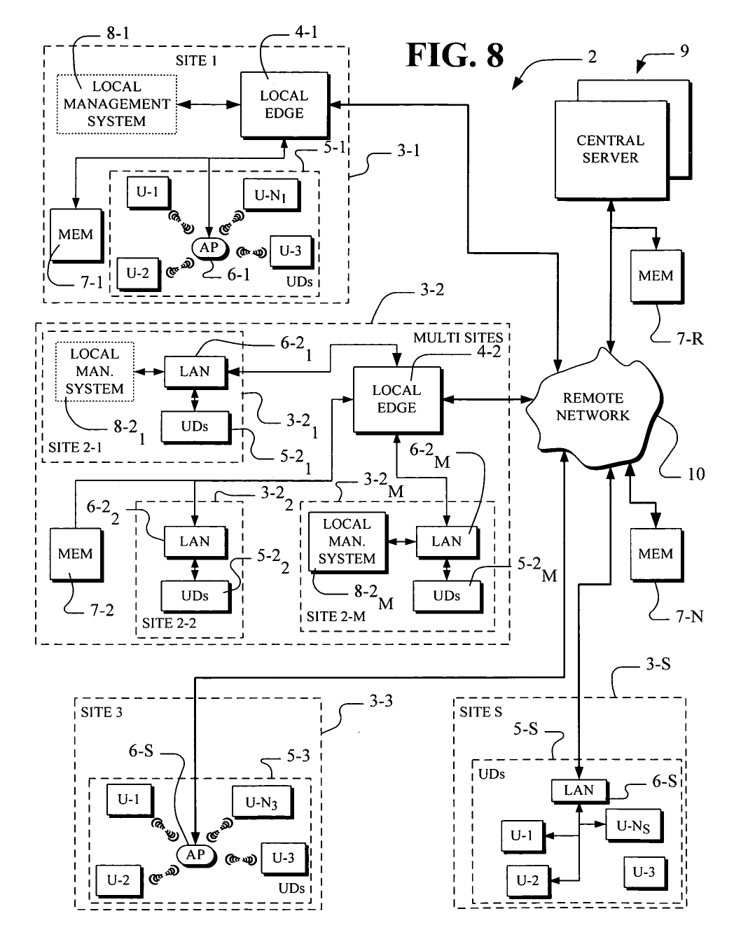

FIG. 8 depicts a distributed service system 2 where one or more servers, such as central servers 9 and/or local edge servers 4 (including servers 4-1 and 4-2 provide distributed availability of application programs or other functions and other information and functions to client user devices 5 (including user devices 5-1, 5-2, 5-3, . . . , 5-S). The user devices 5 are interconnected by networks 6 including the local area networks 6-1, 6-2, 6-3, . . . , 6-S. The central servers 9, and associated storage memory 7-R, communicate through the remote network 10 to the elements of the distributed service system 2 and in particular with the user devices 5 for providing information and functions to the user devices 5. The central servers 9 may communicate with the user devices 5 through the local edge servers 4 at sites 3-1 and 3-2 or directly at sites 3-3, . . . , 3-S and, in one preferred embodiment, operates using the WINFRAME system from Citrix Systems, Inc. Other embodiments employ server-based computing systems from other vendors. The user devices 5 are “thin clients”, “full (fat) clients” or other computing devices.

Referring to FIG. 8, the client user devices 5 are located at the different sites 3, including sites 3-1, 3-2, 3-3, . . . , 3-S. Further, any particular site 3 may be partitioned into sub-sites such as the sub-sites 3-2₁, 3-2₂, . . . , 3-2_{M} within the site 3-2. The sites 3 may be located at many different locations whether on local area networks or wide area networks and extending anywhere around the world.

In FIG. 8, site 3-1 (SITE 1) includes the local edge server 4-1, a wireless local area network and access point 6-1, storage memory 7-1 and client users U-1, U-2, U-3, . . . , U-N₁. The users U-1, U-2, U-3, . . . , U-N₁ are connected through the wireless access point (AP) 6-1 forming the wireless local area network. Also, site 3-1 includes a local management system 8-1 which interconnects through the local edge server 4-1. In a preferred embodiment, the users U-1, U-2, U-3, . . . , U-N₁ are thin clients and the local edge server 4-1 is a Citrix server of the type described in the '726 patent. Alternatively, the functions of the Citrix server of the type described in the '726 patent can be performed entirely or partly in the central servers 9. The local management system 8-1 is a system typically not under control of the central servers 9 or other servers 4 in the distributed service system 2 of FIG. 8.

In one example, the local management system 8-1 is a legacy computer system installed at one enterprise. For example, if the entity is a hotel, the local management system is typically the registration, billing and accounting system used by the hotel's property management system to service guest accounts. In that example, distributed service system 2, other than the local management system 8-1, provides client user devices 5-1 for use by the hotel guest for accessing information and functions of interest to the guests. The user devices 5 in such an example are located in the guest rooms, in the lobby and in other public and private locations about the hotel. The information and functions available to the guests on the thin client users include, for example, internet access for checking e-mail or other Web functions, Microsoft Word for word processing functions, other Microsoft Office applications, Hotel services such as room service food ordering, movie selection, account settlement and many others.

In FIG. 8, sites 3-2 (MULTI SITES) include a number of sub-sites 3-2₁, 3-2₂, . . . , 3-2_{M}. In sub-site 3-2₁, the user devices 5-2₁ include a number of users like the client users U-1, U-2, U-3, . . . U-N_{E} of user devices 5-1 of site 3-1. The local edge server 4-2 connects through local area network 6-2₁ to the user devices 5-2₁. Also, sub-site 3-2₁ includes a local management system 8-2₁which interconnects through local area network 6-2₁ to the user devices 5-2₁. In a preferred embodiment, the user devices 5-2₁ are thin clients and the local edge server 4-2 is a Citrix server of the type described in the '726 patent. Alternatively, the functions of the Citrix server of the type described in the '726 patent can be performed entirely or partly in the central servers 9. The local management system 8-2₁ is a system typically not under control of the central servers 9 or other servers 4 in the distributed service system 2 of FIG. 8.

In sub-site 3-2₁, the user devices 5-2₁ include a number of users like the client users U-1, U-2, U-3, . . . , U-N_{E} of user devices 5-1 of site 3-1. The local edge server 4-2 connects through local area network 6-2₁ to the user devices 5-2₁. Also, sub-site 3-2₁ includes a local management system 8-2₁ which interconnects through local area network 6-2₁ to the user devices 5-2₁. In one preferred embodiment, the user devices 5-2₁ are thin clients or full clients and the local edge server 4-2 is a Citrix server of the type described in the '726 patent. Alternatively, the functions of the Citrix server of the type described in the '726 patent can be performed entirely or partly in the central servers 9. The local management system 8-2₁ is a system typically not under control of the central servers 9 or other servers 4 in the distributed service system 2 of FIG. 8.

In sub-site 3-2₂, the user devices 5-2₂ include a number of users like the client users U-1, U-2, U-3, . . . , U-N_{E} of user devices 5-1 of site 3-1. The local edge server 4-2 connects through local area network 6-2₂ to the user devices 5-2₂. Also, sub-site 3-2₂ does not include a local management system 8. In one preferred embodiment, the user devices 5-2₂ are thin clients or full clients and the local edge server 4-2 is a Citrix server of the type described in the '726 patent. Alternatively, the functions of the Citrix server of the type described in the '726 patent can be performed entirely or partly in the central servers 9.

In sub-site 3-2_{M}, the user devices 5-2_{M} include a number of users like the client users U-1, U-2, U-3, . . . , U-N_{E} of user devices 5-1 of site 3-1. The local edge server 4-2 connects through local area network 6-2_{M} to the user devices 5-2_{M}. Also, sub-site 3-2_{M} includes a local management system 8-2_{M} which interconnects through local area network 6-2_{M} to the user devices 5-2_{M}. In one preferred embodiment, the user devices 5-2_{M} are thin clients or full clients and the local edge server 4-2 is a Citrix server of the type described in the '726 patent. Alternatively, the functions of the Citrix server of the type described in the '726 patent can be performed entirely or partly in the central servers 9. The local management system 8-2_{M} is a system typically not under control of the central servers 9 or other servers 4 in the distributed service system 2 of FIG. 8.

In FIG. 8, site 3-3 (SITE 3) includes a wireless local area network and access point 6-3 and client users U-1, U-2, U-3, . . . , U-N₃. The users U-1, U-2, U-3, . . . , U-N_{E} are connected through the wireless access point (AP) 6-3 that forms a wireless local area network. The functions of a Citrix server of the type described in the '726 patent are performed in the central servers 9.

In FIG. 8, site 3-S (SITE S) includes a wired local area network 6-S and client users U-1, U-2, U-3, . . . , U-N_{S}. The users U-1, U-2, U-3, . . . , U-N_{E} are connected through a wireless access point (AP) of the wireless local area network 6-1. The functions of a Citrix server of the type described in the '726 patent are performed in the central servers 9.

While the invention has been particularly shown and described with reference to preferred embodiments thereof it will be understood by those skilled in the art that various changes in form and details may be made therein without departing from the scope of the invention.

1. An information technology system for providing functions to users comprising:
a network,
a server, connected to the network, for delivering said functions and for providing function information and server-controlled information to said users,
a plurality of user devices, connectable to the network, each user device displaying a portal enabling users to request said functions from the server and each user device displaying multiple regions including,
a first region for display of function information from one or more of said functions,
one or more second regions, lockable by said sever to prevent changes by users, for display of said server-controlled information.

2. The system of claim 1 wherein said function is controlled by a user.

3. The system of claim 1 wherein one or more of said second regions displays advertisements served by the server.

4. The system of claim 1 wherein said first region displays application programs under control of a user.

5. The system claim 1 wherein one or more of said user devices is disconnected from said server where each disconnected user device operates under local control of said user device.

6. The system claim 1 wherein one or more of said user devices includes a cache for storing server-controlled information, wherein one or more of said user devices is disconnectable from said server, wherein each disconnected user device operates under local control of said user device and wherein said one or more second regions displays the stored server-controlled information from said cache.

7. The system claim 6 wherein said server-controlled information is advertisements.

8. The system claim 6 wherein said server-controlled information is refreshed in said cache for each of said user devices connected to the server.

9. The system claim 1 wherein said server includes a server portal control for controlling the establishment of said first region and said second regions for said user devices and wherein each of said user devices includes a device control responsive to said server portal control for establishing said first region and said second regions.

10. The system claim 9 wherein each said device control includes a sequencer for sequencing, in a sequence of iterations, through a region creator to establish for each iteration one of said second regions.

11. The system claim 10 wherein each region creator includes creation modules to establish one of said second regions, said creation modules including,
a first module to initiate creation of a new region on the portal display,
a second module to propose a new region position on the portal display,
a third module to query if the new region position conflicts with any other region position on the portal display,
a fourth module, if the new region position conflicts with any other region position, for re-arranging the portal and repeating execution of the second and third modules,
a fifth module, if the new region position does not conflict with any other region position, to set the new region position on the portal display,
a sixth module to lock the new region position so as to be always-on-top and not closeable by a user.

12. The system claim 10 wherein for one of said iterations a server-controlled region is populated and installed on said portal.

13. The system claim 10 wherein for one of said iterations a first one of said second regions is installed as a navigation bar for navigation by a user on said portal.

14. The system claim 10 wherein for one of said iterations a second one of said second regions is installed as a first advertising bar for advertising on said portal.

15. The system claim 10 wherein for one of said iterations a third one of said second regions is installed as a second advertising bar for advertising on said portal.

16. The system claim 10 wherein for one of said iterations, data mining is started.

17. The system claim 10 wherein one or more of said user devices includes a cache for storing server-controlled information and for one of said iterations storage of server-controlled information in said cache is initiated.

18. An information technology system for providing computer applications to users comprising:
a network,
a server, connected to the network, for executing said applications and for providing application information and server-controlled information to said users,
a plurality of user devices, connectable to the network, each user device displaying a portal enabling users to request application execution on the server and each user device displaying multiple regions including,
a first region for display of application information from one or more of said applications where one or more of said applications are controlled by a user,
one or more second regions, lockable by said server to prevent changes by users, for display of said server-controlled information.

19. The system of claim 18 wherein one or more of said second regions displays advertisements under control of said server concurrently with display of the application information.

20. The system of claim 18 wherein one or more of said second regions displays service messages for users under control of said server.

21. The system of claim 18 wherein said first region displays application programs.

22. The system of claim 21 wherein said application programs include office programs.

23. The system of claim 22 wherein said office programs include word processor, spreadsheet and presentation programs.

24. The system of claim 21 wherein said programs include an internet browser program.
